(19) United States
(12) Patent Application Publication
(10) Pub. No.: US 2013/0151103 A1
(43) Pub. Date: Jun. 13, 2013

(54) METHOD FOR BRAKE REGENERATION

(71) Applicant: GM GLOBAL TECHNOLOGY OPERATIONS LLC, Detroit, MI (US)

(72) Inventor: Reinhold ENDERS, Mainz (DE)

(73) Assignee: GM GLOBAL TECHNOLOGY OPERATIONS LLC, Detroit, MI (US)

(21) Appl. No.: 13/710,070

(22) Filed: Dec. 10, 2012

(30) Foreign Application Priority Data
Dec. 10, 2011 (DE) 102011120791.4

(51) Int. Cl. B60L 7/26; B60L 7/18

(52) U.S. Cl. CPC B60L 7/26; B60L 7/18
USPC 701/70

(57) ABSTRACT

A method for controlling brakes acting through frictional connection, in particular for a vehicle having an energy conversion device which is configured to convert movement energy into storable energy during a braking operation, is provided. The method comprises sensing a runtime value which has elapsed since a last operation of the brake and comparing with a time constant, sensing a braking operation with a braking force and comparing with a predetermined braking force value, and, if the braking force exceeds the predetermined braking force value and the runtime value is longer than the time constant, initiating a brake regeneration during which on a first axle a first braking force component is increased and a second braking force component on a second axle is reduced, so that a sum of the braking force components reaches the braking force.

### CROSS-REFERENCE TO RELATED APPLICATION

This application claims priority to German Patent Application No. 10 2011 120 791.4, filed Dec. 10, 2011, which is incorporated herein by reference in its entirety.

### TECHNICAL FIELD

The technical field relates to a method for controlling brakes acting by frictional connection in particular for a vehicle having an energy conversion device that is equipped to convert movement energy into storable energy during a braking operation.

### BACKGROUND

In the case of hybrid vehicles, kinetic movement energy can be converted into storable electrical energy during a brake application. This results in that conventional brakes acting through frictional connection are hardly used in everyday life. Because of this, individual components of the brake, in particular brake discs of a disc brake may corrode. On vehicles that are conventionally driven by combustion engines alone the brakes on the rear axle may be used little as well in the case of minor decelerations.

Therefore, it may be desirable to prolong the lifespan of a brake acting by frictional connection. In addition, other objects, desirable features and characteristics will become apparent from the subsequent summary and detailed description, and the appended claims, taken in conjunction with the accompanying drawings and this background.

### SUMMARY

Accordingly, provided is a method for controlling brakes acting by frictional connection, in particular for a vehicle having an energy conversion device, which is equipped to convert movement energy into storable energy during a braking operation, wherein the method comprises capturing a runtime value, which has elapsed since a last operation of the brake and comparison with a time constant. The method comprises capturing a braking operation with a braking force and comparison with a predetermined braking force value, and if the braking force exceeds the predetermined braking force value and the runtime value is longer than the time constant, initiating a brake regeneration during which on a first axle a first braking force component is increased and a second braking force component on a second axle is decreased, so that a sum of the braking force components reaches the braking force.

The first axle can be the front axle and the second axle can be the rear axle. The energy conversion device can be an electric generator that can be connected to a battery. Through this method, brakes which are subjected to low load during the usual driving operation are subjected to greater load upon a brake application initiated by the driver and cleaned in the process. A lifespan of a frictional connection brake can be prolonged because of this. A frictional connection brake can be a disc brake or a drum brake. The braking force components are proportional to a fluid pressure of a brake fluid acting on the brakes. The braking force components in the case of an electromechanical brake can also be determined through an electrical signal. The braking force can be determined directly or indirectly via suitable sensors. In the case of an indirect sensing, the braking force that is active or desired by the driver can be deduced from suitable parameters connected to the braking force. A stroke of a brake cylinder, a brake pedal travel and a brake pedal force are mentioned here as examples for such parameters. On hybrid vehicles having energy conversion machines which convert kinetic energy into storable energy during braking, the braking force desired by the driver is determined anyhow.

In an exemplary embodiment, the runtime value is a stationary state time of the vehicle, wherein the time constant is set to at least about 24 hours, in one example, at least about 48 hours, and in another example, at least about 72 hours.

Following an extended stationary state it can be assumed that the brake subjected to less load already shows first signs of friction value changes, in one example, in the case of humid climatic conditions. For this reason, a brake regeneration can be carried out as standard during brake applications after an extended stationary state. In vehicles that are intended for warm and humid climatic zones, correspondingly shorter time constants than in vehicles for dry regions can be predetermined.

According to an exemplary embodiment, the second braking force component on the second axle is limited during the brake regeneration to a component that is adequate for friction means pairings to contact each other.

Here, the brakes of the second axle are activated so that the brake linings contact the brake disc. Because of this, the so-called lining clearance is offset on the second axle, so that in the case of an increase of the demanded braking force, during which the brake regeneration is interrupted and the vehicle continues braking with a conventional brake force distribution, the brakes respond immediately.

According to one exemplary embodiment, the brake regeneration is therefore deactivated following the exceeding of a maximum braking force value and a brake force distribution provided for the vehicle is activated.

According to another exemplary embodiment, the brake regeneration is deactivated during cornering. Because of this, an undesired influence on the steering behavior of the vehicle can be prevented.

According to another exemplary embodiment, the brake regeneration is repeated in the case of a plurality of braking operations following one another until a sum of individual time durations of the braking operations has reached a predetermined brake cleaning duration. Here, the brake cleaning desired through the brake regeneration can be achieved in a short time through one or a plurality of intensive, short brake applications.

Because of this, the brake can be cleaned in successive braking operations in normal driving mode in which only short brake applications are frequently carried out.

In another exemplary embodiment, the method additionally comprises capturing a vehicle speed, and comparing the vehicle speed with a comparison value, wherein a brake regeneration is initiated only when the vehicle speed is greater than the comparison value.

This exemplary embodiment is based on the idea that a brake regeneration is more effective during elevated vehicle speeds, that the friction component on the brakes is correspondingly higher. The comparison value can be set to about 60 km/h for example.

The braking force can be determined from an acceleration, wherein the acceleration can be sensed through an acceleration sensor provided in the vehicle.

The braking force results in an acceleration or a deceleration which acts on the vehicle against the travelling direction. From a known dead weight and a load set to a medium value, the braking force that happens to be active at any one time can be deduced from the active acceleration. For sensing the acceleration, an acceleration sensor that is usually present for an electronic stability program anyhow can be used.

According to an exemplary embodiment, the deceleration value is set to values of at least about 0.1 g, in one example, at least about 0.2 g, and in another example, at least about 0.3 g, while “g” is to mean the earth's gravitational acceleration.

With these deceleration values, an adequate cleaning of the brakes can sometimes already be ensured.

According to another exemplary embodiment, the time that elapses during a full brake application, during which the vehicle speed exceeds a predetermined full braking force value and the braking force exceeds a predetermined braking force value, is counted as a time duration of the brake regeneration.

During a full brake application, the brakes are subjected to major load. A brake regeneration after a full brake application is initially no longer necessary for a certain time since the brakes have been braked clean when subjected to major loading.

The described method and the exemplary embodiments can be provided in a motor vehicle, in one example, in a control unit.

The control unit can comprise a digital microprocessor unit (CPU) data-connected to a storage system and a bus system, a working memory (RAM) and a storage means. The CPU is designed to process commands which are executed as a program that can be stored in a storage means, to capture input signals from the data bus and output output signals to the data bus. The storage system can comprise different storage media such as optical, magnetic, solid state and other non-volatile media on which a corresponding computer program for carrying out the method and the advantageous configurations is stored. The program can be of such a nature that it embodies or is able to carry out the method described here, so that the CPU can carry out the methods and thereby control the motor vehicle.

Suitable for carrying out a method is a computer program, which comprises a program code means in order to carry out any of the methods when the program is executed on a computer.

Here, the computer program can comprise program code means in order to carry out the various methods, when the program is carried out on a computer. The computer program can be read into already existing control units with simple means and used in order to control a plurality of brakes.

Provided for this is a computer program product having program code means which are stored on a computer-readable data carrier in order to carry out the method according to any one of the exemplary embodiments, when the program product is executed on a computer. The computer program product can also be integrated in control units as retrofit option.

According to the various teachings of the present disclosure, also provided is an apparatus for controlling brakes acting by frictional connection, in one example, for a vehicle having an energy conversion device that is equipped to convert movement energy during a braking operation into storable energy, wherein the apparatus includes means for capturing a runtime value that has elapsed since a last operation of the brake and comparison with a time constant. The apparatus can also include means for capturing a braking operation with a braking force and comparing the braking force with a predetermined braking force value, and means for initiating a brake regeneration, during which on a first axle a first braking force component is increased and a second braking force component on a second axle is reduced, so that a sum of the braking force components reaching the braking force, wherein the brake regeneration is initiated with means when the braking force exceeds the predetermined braking force value and the runtime value is longer than the time constant.

With an exemplary embodiment of the apparatus, the runtime value is a stationary state time of the vehicle, wherein the time constant is set to at least about 24 hours, in one example, at least about 48 hours, and in another example, at least about 72 hours.

With another exemplary embodiment of the apparatus, the means are provided which during the brake regeneration limit the second braking force component on the second axle to a component that is adequate for friction means pairings for friction means pairings to be in contact with each other.

Because of this, the lining clearance between the friction means pairings that has to be overcome before each braking operation is offset in preparation for a possibly stronger brake application (upon which the brakes of the second axle are again activated normally).

In one exemplary embodiment of the apparatus, the means are designed to deactivate the brake regeneration following the exceeding of a maximum braking force value and to activate a brake force distribution provided for the vehicle.

In another exemplary embodiment, means are provided which deactivate the brake regeneration during cornering.

Another exemplary embodiment of the apparatus provides means for capturing a vehicle speed, means for comparing the vehicle speed with a comparison value, and means for initiating the brake regeneration, which means initiate the brake regeneration only when the vehicle speed is greater than the comparison value, are present.

An exemplary design of the apparatus comprises that means are provided which repeat the brake regeneration upon a plurality of braking operations following in succession, until a sum of individual time durations of the braking operations has reached a predetermined brake regeneration duration.

In another exemplary embodiment of the apparatus, means are present which following the reaching of the brake regeneration duration described in the preceding paragraph carry out a brake regeneration on the second axle, wherein via means during the brake regeneration, the first braking force component on the first axle is reduced and the second braking force component on the second axle is increased, so that a sum of the braking force components reaches the braking force.

With another exemplary embodiment of the apparatus, the means for capturing the braking force are formed out of an acceleration sensor provided in the vehicle, wherein the acceleration sensor is configured to sense an acceleration acting on the vehicle.

According to another exemplary embodiment, a deceleration that is proportional to the braking force value is set to at least about 0.1 g, in one example, to at least about 0.2 g, and in another example, to at least about 0.3 g.

During these decelerations, the brake absorbs a high braking power so that a good cleaning effect can be achieved.

In another exemplary embodiment of the apparatus, means are provided furthermore which upon a full brake application carried out from a vehicle speed which exceeds a predetermined full braking force value, and a braking force, which exceeds a predetermined braking force value, captures the period of time needed for the full brake application, valuing it as time duration of a brake regeneration.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 schematically illustrates in a top view a motor vehicle with an electric motor and a combustion engine,

FIG. 2 is a flow diagram of an exemplary method for controlling the brakes, and

FIG. 3 is a flow diagram of a further exemplary method for controlling the brakes.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

In the Figures, components that are the same or functionally have the same effect are provided with same reference characters.

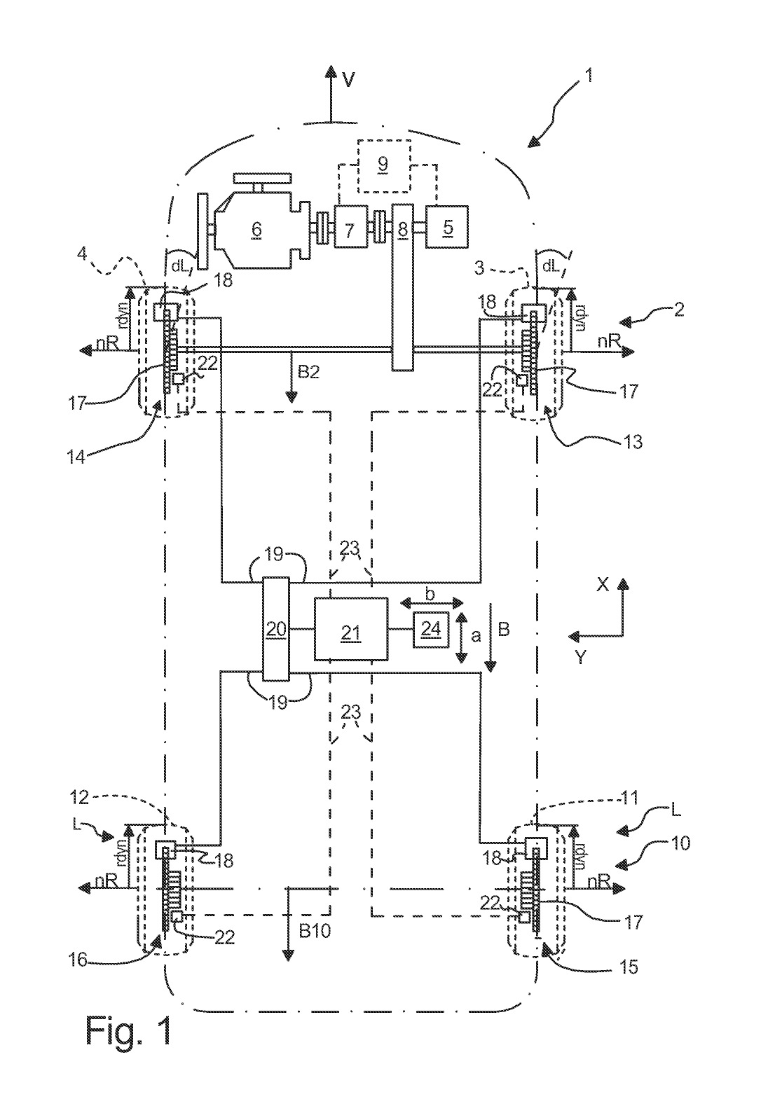

In a schematic representation, FIG. 1 shows a motor vehicle 1, wherein wheels 3 and 4 arranged on a front, first axle 2 can be driven via an electric motor 5 and a combustion engine 6. The combustion engine 6 can drive a generator 7 and a transfer gear 8. The transfer gear 8 can also be driven by the electric motor 5. By way of the transfer gear 8, a drive power output by the electric motor 5 or the combustion engine 6 can be transmitted onto the wheels 3 and 4. Upon a deceleration of the vehicle 1, the generator 7 can be operated as energy conversion device via the transfer gear 8 and movement energy reclaimed. The power output to the generator 7 by the combustion engine 6 or by the transfer case 8 can be stored in a battery 9.

The vehicle 1, in addition, comprises a rear, second axle 10, with non-driven wheels 11 and 12. All wheels 3, 4, 11 and 12 can be braked via brakes 13, 14, 15, 16 individually acting on each wheel 3, 4, 11 and 12 through frictional connection. The brakes 13, 14, 15, 16 each have a brake disc 17 and a brake caliper 18. The brake calipers 18 are connected to a brake distributor 20 via brake lines 19. The brake discs 17 and the brake calipers 18 form a friction means pairing upon activation of the brakes 13, 14, 15, 16.

In the brake distributor 20, devices for distributing a braking force over the brakes 13, 14, 15, 16 can be provided, such as for example inlet valves and outlet valves of anti-lock braking system, an electronic stability program or an anti-slip control.

The brake force distributor 20 is signal-connected to a control unit 21. In the control unit 20, a storage system, a bus system, a digital microprocessor unit (CPU), a working memory (RAM) and a storage means can be arranged.

On each wheel 3, 4, 11, 12, wheel rotational speed sensors 22 are additionally arranged, which are connected to the control unit 21 via lines 23 in a data-transmitting manner.

Furthermore, the vehicle 1 comprises an acceleration sensor 24, which is configured to sense longitudinal accelerations a and transverse accelerations b acting on the vehicle. Furthermore, the wheels 3 and 4 on the front axle 2 can be steered in both directions by a steering angle dL.

In that during braking processes with low decelerations a, such as frequently occur in everyday operation, the conventional brakes 13, 14, 15, 16 are subjected to low load, the brake discs 17 can corrode. This causes an accelerated aging of the brake discs 17.

During the deceleration, a wheel slip L acts on each wheel 3, 4, 11, 12. The wheel slip L is calculated from a wheel rotational speed nR, a dynamic wheel radius rdyn and a vehicle speed v as:

L=((rdyn*nR)−v)/v).

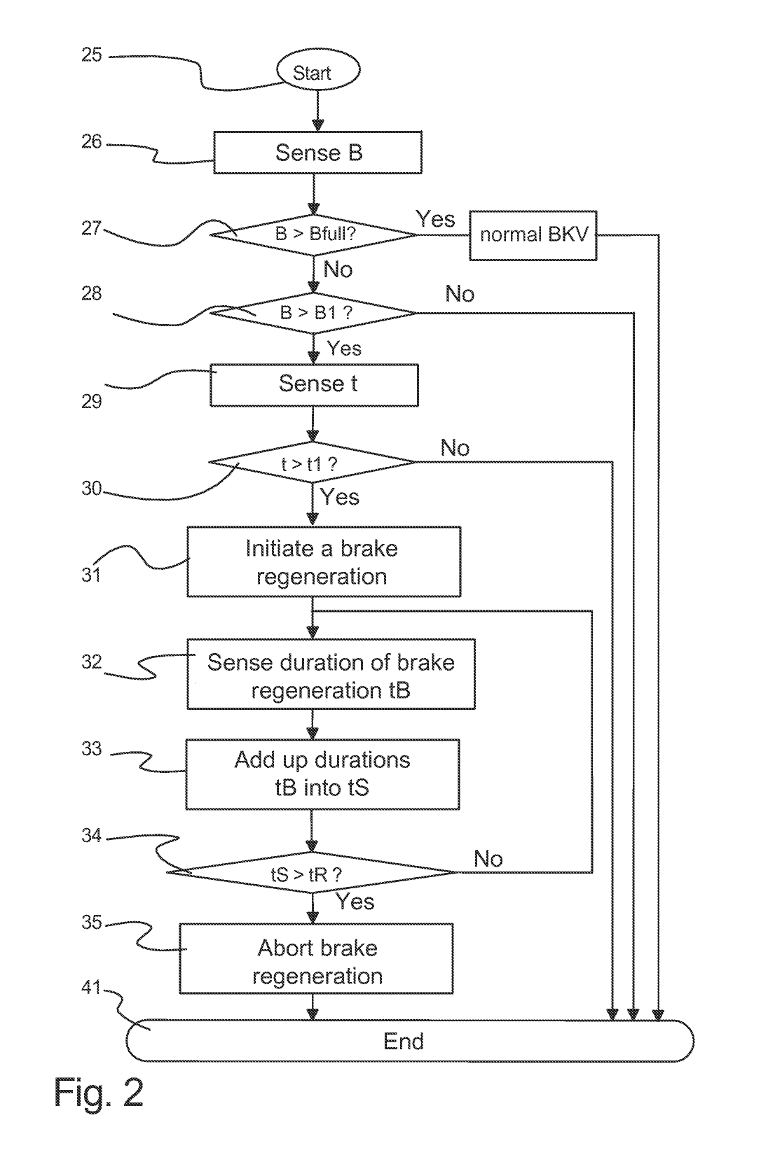

In connection with FIG. 2, reference is made to the elements and their reference characters shown in FIG. 1. FIG. 2 shows a method for controlling the brakes 13, 14, 15, 16. The method can be carried out as program in the control unit 21. After the start 25, a braking force B is determined in 26, which can be carried out via sensors or via the acceleration sensor 24. In a following query 27 it is queried if the value for the braking force B is higher than a preset full brake application value Bfull. If this is the case, a normal brake force distribution BKV over the axles 2 and 10 is initiated, the method is ended. In 28, it is queried if the braking force B is greater than a braking force value B1. Because of this, the brake regeneration is only carried when the braking power or braking force component to be expected is indeed adequately large in order to achieve a good cleaning effect. If the answer is “No”, the program is ended upon which it recommences. If the answer is “Yes”, it is subsequently sensed in 29 if a certain time has elapsed since the last operation of the brake. To this end, a runtime value t, which has elapsed since a last operation of the vehicle 1 or of the brakes 15 and 16 of the rear axle 10 or since the last operation of the vehicle 11 is sensed. This runtime value t is compared in a query 30 with a predetermined period of time t1, which for example can be set to at least about 24 hours, in one example to at least about 48 hours, and in another example to at least about 72 hours. If the value for t is lower than the predetermined period of time t1, the answer is “No” and the program is ended, upon which it is restarted. If the answer is “Yes”, a brake regeneration is carried out in 31, upon which the brakes 15 and 16 of the first front axle 2 generate a predominant braking force component. In the simplest case, the braking force component B2 on the second, rear axle 10 is set to a component that is adequate for applying the friction means pairings 17 and 18 and the rear axle 10 takes over the complete braking power. In the process, the brakes 13 and 14 are cleaned and any lash rust that has developed, is scraped off.

In 32, a duration tB is sensed, during which a brake regeneration takes place. When the value tB reaches a preset value, the brakes 15 and 16 have been adequately cleaned and regenerated. To this end, periods of time can also be utilized during which a full brake application took place. A normal driving cycle can be carried out and kinetic energy during the braking, converted into electric energy on the generator 7. In 33, a sum of individual time durations tB which occurred during the last complete brake regeneration is added up and a sum tS formed from this. If the sum tS exceeds a preset brake regeneration duration tR, which is queried in 34, the brake regeneration on axle 2 can be aborted in 35. If tS is thus longer than tR, the answer is “Yes” and the program is ended in 41, upon which it recommences at the start 25. If the answer is “No”, the brake regeneration is continued.

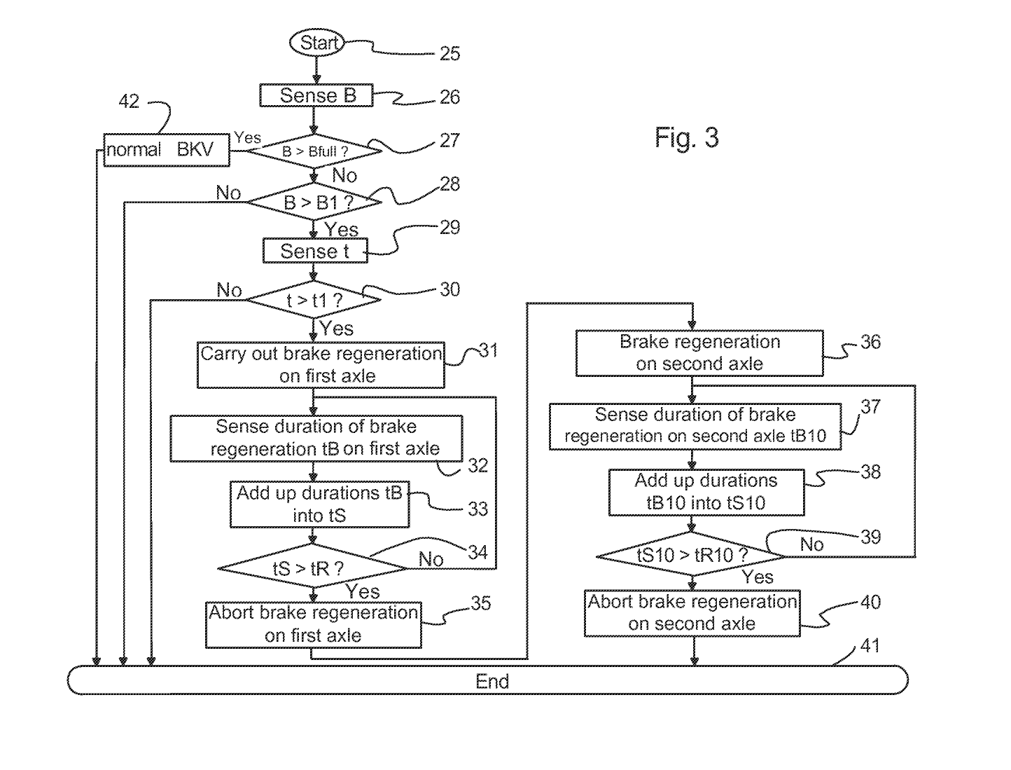

FIG. 3 shows a configuration of the method, with which the brakes 15 and 16 on the rear axle 10 can likewise be regenerated. What was said in connection with the FIG. 2 applies to blocks 25 to 35. After 35, a brake regeneration is carried out on the rear axle 10 in 36. This is carried out analogously to the brake regeneration of the first, front axle 2, in that the second braking force B10 is increased and the first braking force B2 is reduced. A time duration tB10 is again sensed in 38, which indicates how long one or a plurality of brake regenerations have already been running. In 38, the duration tB10 or a plurality thereof is added up to the sum tS10. In 39 it is queried if the sum tS10 is greater than a preset brake regeneration duration tR10. If this is the case, the brake regeneration on the second axle 10 is aborted in 40 and the program ended in 41, upon which it recommences.

In one exemplary embodiment, the methods according to the FIGS. 2 and 3 take place only when an installed software has detected a prolonged stationary state of the vehicle 1. In another exemplary embodiment, the brake regeneration is always aborted when the vehicle 1 travels around a corner. This can be detected via the steering angle dL or via a vehicle transverse acceleration b sensed on the acceleration sensor 24.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A method for controlling brakes acting through frictional connection for a vehicle having an energy conversion device that converts movement energy into storable energy during a braking operation, comprising:
sensing a runtime value that has elapsed since a last operation of the brake and comparing the runtime value with a time constant;
sensing a braking operation with a braking force and comparing the braking force with a predetermined braking force value; and
if the braking force exceeds the predetermined braking force value and the runtime value is longer than the time constant, initiating a brake regeneration during which on a first axle a first braking force component is increased and a second braking force component on a second axle is reduced, so that a sum of the braking force components reaches the braking force.

2. The method according to claim 1, wherein the runtime value is a stationary state time of the vehicle, and the time constant is set to at least about 24 hours.

3. The method according to claim 1, wherein the runtime value is a stationary state time of the vehicle, and the time constant is set to at least about 48 hours.

4. The method according to claim 1, wherein during the brake regeneration the second braking force component on the second axle is limited to a component that is adequate for having friction means pairings contacting each other.

5. The method according to claim 1, further comprising:
after exceeding a maximum braking force value, deactivating the brake regeneration and activating a brake force distribution provided for the vehicle.

6. The method according to claim 1, further comprising:
deactivating the brake regeneration during cornering.

7. The method according to claim 1, further comprising:
sensing a vehicle speed; and
comparing the vehicle speed with a comparison value,
wherein the brake regeneration is only initiated when the vehicle speed is greater than the comparison value.

8. The method according to claim 1, further comprising:
repeating the brake regeneration upon a plurality of braking operations following in succession until a sum of individual time durations of the brake regeneration has reached a predetermined brake regeneration duration.

9. The method according to claim 8, wherein after reaching the brake regeneration duration a brake regeneration is carried out on the second axle, while the first braking force component on the first axle is reduced and the second braking force component on the second axle is increased so that a sum of the braking force components reaches the braking force.

10. The method according to claim 1, further comprising:
determining the braking force from an acceleration, and the acceleration is sensed by an acceleration sensor provided in the vehicle.

11. The method according to claim 1, wherein a deceleration that is proportional to the braking force value is set to at least about 0.1 g.

12. The method according to claim 1, wherein a deceleration that is proportional to the braking force value is set to at least about 0.3 g.

13. The method according to claim 1, wherein upon a carried-out full brake application a time duration required for the full brake application is counted as time duration of the brake regeneration from a vehicle speed, which exceeds a predetermined value and a braking force, which exceeds a predetermined full braking force value.

14. A motor vehicle, comprising:
an energy conversion device that converts movement energy into storable energy during a braking operation;
a first axle having a first pair of brakes;
a second axle having a second pair of brakes; and
a control unit that:
senses a runtime value that has elapsed since a last operation of the brake and compares the runtime value with a time constant;
senses a braking operation with a braking force and compares the braking force with a predetermined braking force value; and
if the braking force exceeds the predetermined braking force value and the runtime value is longer than the time constant, intiates a brake regeneration during which on a first axle a first braking force component is increased and a second braking force component on a second axle is reduced, so that a sum of the braking force components reaches the braking force.

15. A computer program product, comprising:
a non-volatile storage medium readable by a processor and storing instructions for execution by the processor for performing a method comprising:
sensing a runtime value that has elapsed since a last operation of the brake and comparing the runtime value with a time constant;
sensing a braking operation with a braking force and comparing the braking force with a predetermined braking force value;
if the braking force exceeds the predetermined braking force value and the runtime value is longer than the time constant, initiating a brake regeneration during which a first braking force component is increased and a second braking force component is reduced, so that a sum of the braking force components reaches the braking force; and
repeating the brake regeneration upon a plurality of braking operations following in succession until a sum of individual time durations of the brake regeneration has reached a predetermined brake regeneration duration.

16. The computer program product according to claim 15, wherein the method further comprises:
deactivating the brake regeneration during cornering.

17. The computer program product according to claim 15, wherein the method further comprises:
sensing a vehicle speed; and
comparing the vehicle speed with a comparison value,
wherein the brake regeneration is only initiated when the vehicle speed is greater than the comparison value.
